(19) United States
(12) Patent Application Publication
(10) Pub. No.: US 2010/0199818 A1
(43) Pub. Date: Aug. 12, 2010

(54) CUTTING APPARATUS

(76) Inventor: Yueh-Ju LEE, Taoyuan County (TW)

Correspondence Address: BIRCH STEWART KOLASCH & BIRCH, PO BOX 747, FALLS CHURCH, VA, 22040-0747, US

(21) Appl. No.: 12/422,469

(22) Filed: Apr. 13, 2009

(30) Foreign Application Priority Data
Feb. 10, 2009 (TW) 98104139

(51) Int. Cl. B26D 7/10

(52) U.S. Cl. 83/16

(57) ABSTRACT

A cutting apparatus for separating two plate devices is provided, wherein the two plate devices are connected to each other by an adhesive layer. The cutting apparatus includes a base, a carrier movably disposed on the base to hold the plate devices, a wire, and a reel mechanism disposed on the base for moving the wire. The wire cuts through the adhesive layer while the carrier moves with respect to the base, so that the plate devices are separated from each other.

### CROSS REFERENCE TO RELATED APPLICATIONS

This Application claims priority of Taiwan Patent Application No. 098104139, filed on Feb. 10, 2009, the entirety of which is incorporated by reference herein.

### BACKGROUND OF THE INVENTION

1. Field of the Invention

The application relates in general to a cutting apparatus and in particular to a cutting apparatus for separating two plate devices which are connected to each other by an adhesive layer.

2. Description of the Related Art

Referring to FIGS. 1A and 1B, a conventional touch display M primarily includes a display panel D, a touch panel T, and a protection sheet C. As shown in FIG. 1B, the touch panel T is adhered to the display panel D by a light curing adhesive G1. Similarly, the protection sheet C is adhered to the touch panel T by another light curing adhesive G2. Rework or replacement may be required when functional failures or defects occur in the display panel D or the touch panel T. An efficient and stable cutting apparatus is therefore required for separation of the two plate devices.

### BRIEF SUMMARY OF INVENTION

The application provides a cutting apparatus for separating two plate devices, wherein the two plate devices are connected to each other by an adhesive layer. The cutting apparatus includes a base, a carrier movably disposed on the base to hold the plate devices, a wire, and a reel mechanism disposed on the base for moving the wire. The wire cuts through the adhesive layer while the carrier moves with respect to the base, so that the plate devices are separated from each other.

### BRIEF DESCRIPTION OF DRAWINGS

The invention can be more fully understood by reading the subsequent detailed description and examples with references made to the accompanying drawings, wherein:

FIG. 1A is an exploded diagram of a conventional touch display;

FIG. 1B is a sectional view of the conventional touch display of FIG. 1A;

FIG. 2A is a top view of a cutting apparatus in accordance with an embodiment of the invention;

FIG. 2B is perspective diagram of a carrier of the cutting apparatus in FIG. 2A; and

FIG. 3A is a top view of a wire cutting into a touch display;

FIG. 3B is a perspective diagram of a wire cutting into a touch display; and

FIG. 4 is a top view of a wire cutting through a touch display.

### DETAILED DESCRIPTION OF INVENTION

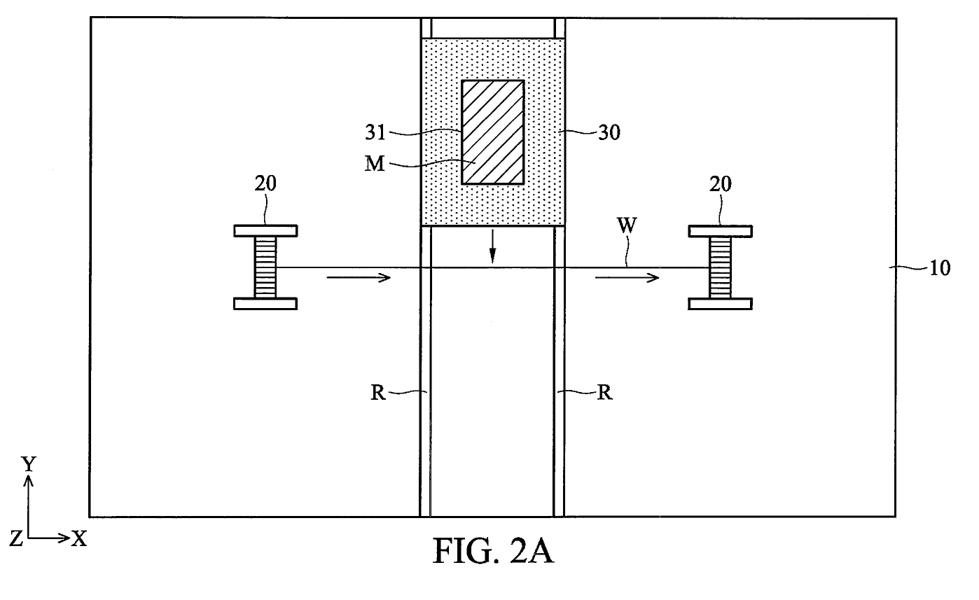

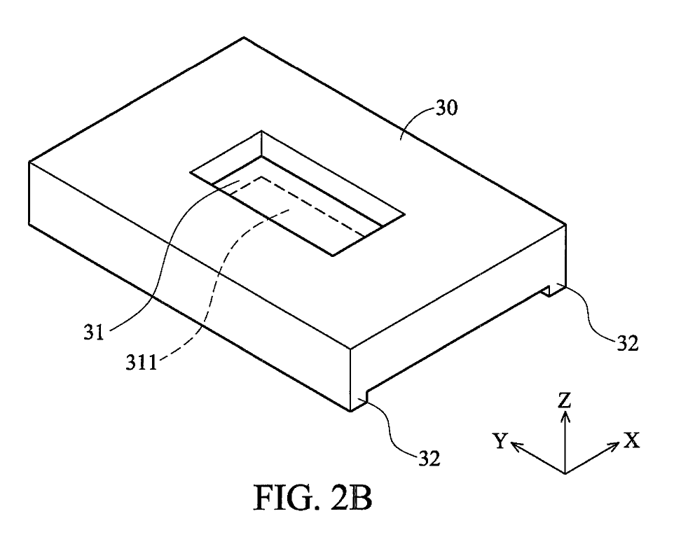

Referring to FIGS. 2A and 2B, an embodiment of a cutting apparatus comprises a base 10, a reel mechanism 20, a carrier 30, and a wire W, wherein the base 10 has two rails R substantially parallel to Y axis. The reel mechanism 20 is mounted on the base 10, and the carrier 30 is movably disposed on the rails R. The wire W traverses the rails R and is movable along an X or −X direction by the reel mechanism 20.

As shown in FIGS. 2A and 2B, the carrier 30 has a recess 31 on a top surface thereof. The carrier 30 further has two sliders 32 coupled with the two rails R, so that the carrier 30 may slide along a −Y direction with respect to the base 10.

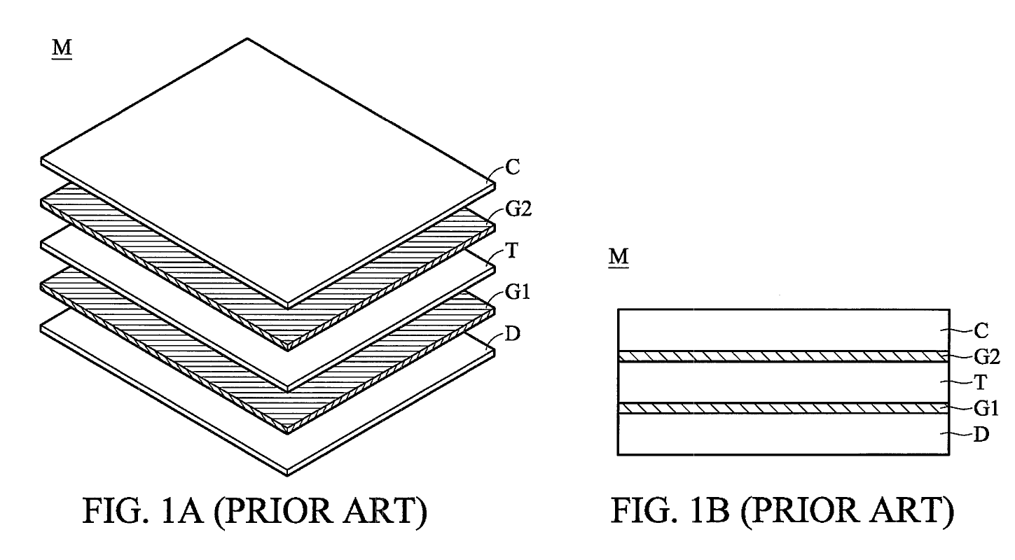

Before cutting the touch display M of FIGS. 1A and 1B, it is disposed in the recess 31 of the carrier 30 with a part thereof projecting from the top surface of the carrier 30. As depicted in FIG. 2B, a heater 311 is provided below the recess 31 for heating the adhesive layers of the touch display M, such as the light curing adhesive G1 and G2 shown in FIGS. 1A and 1B. In some embodiments, the adhesive layers may be thermal setting adhesives or thermal plastic adhesives, and correspondingly, the heater 311 may be replaced by a device for softening or melting of the adhesive layers.

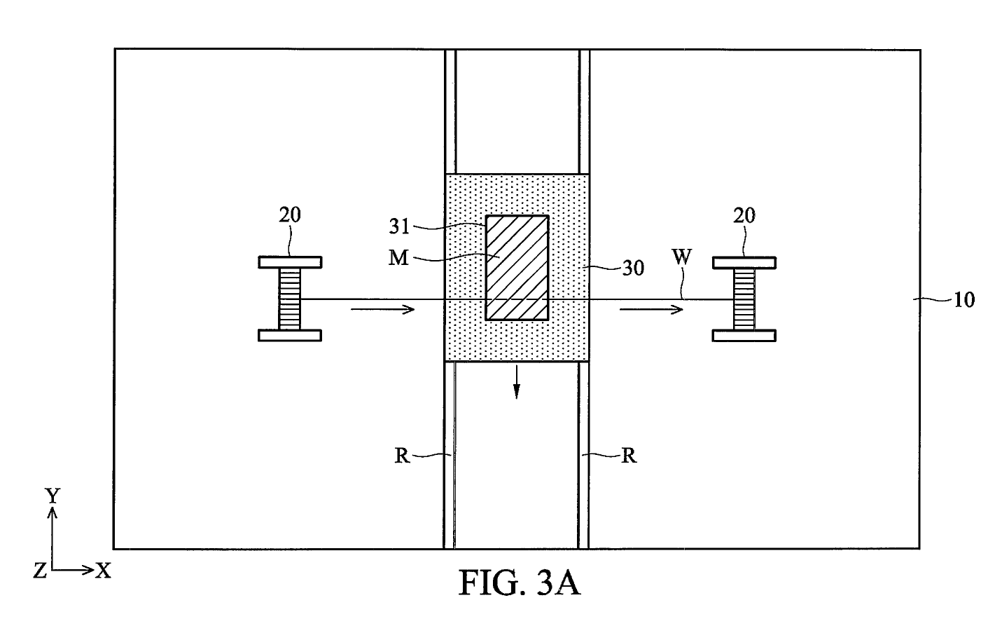

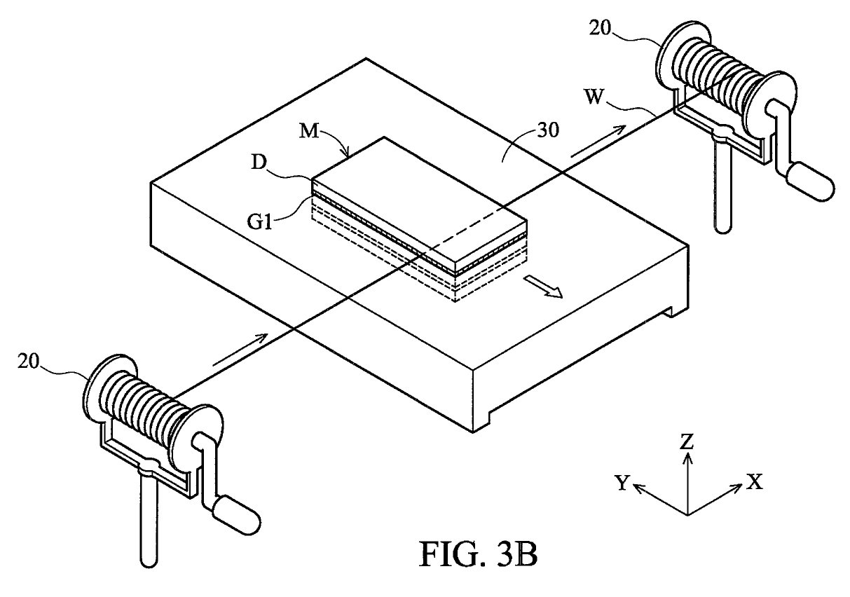

Referring to FIGS. 3A and 3B, with the carrier 30 moving along a −Y direction, the adhesive layer G1 projecting from the carrier 30 contacts the wire W. Subsequently, the wire W cuts into the adhesive layer G1 due to its continuous and stable movement along the X or −X direction by the reel mechanism 20.

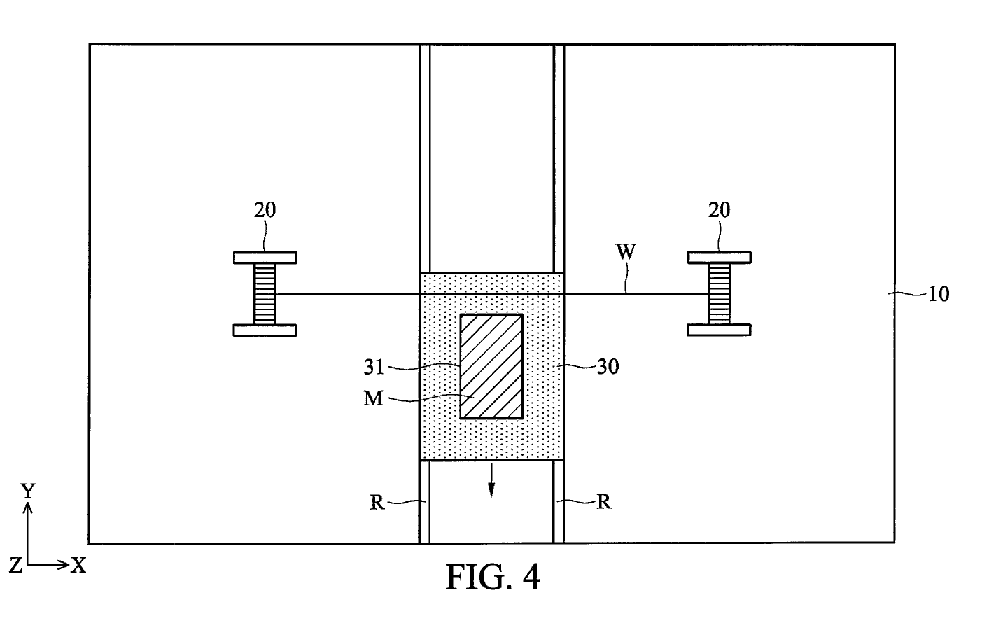

As shown in FIG. 4, the wire W can cut throughout the touch display M with the carrier 30 continuously moving along the −Y direction. Hence, the display panel D and the touch panel T are completely separated from each other. In some embodiments, the cutting apparatus is further applied to cut the adhesive layer between the touch panel T and the protection sheet C, so as to separate them from each other. Additionally, the cutting apparatus can also be applied to separate the protection sheet C and the display panel D when they are connected to each other by an adhesive layer.

In this embodiments, the wire W is driven by the reel mechanism 20 along the X or −X direction, thus facilitating stable and robust cutting efficiency. The wire W can be stainless wire, steel wire, cloth wire, nylon wire, wire saw, or other wire with abrasive grains. The reel mechanism 20 can be an electrical or manual reel, and the carrier 30 can manually slide along the rail R or be driven by a motor.

The application provides a cutting apparatus for separating two plate devices connected to each other by an adhesive layer. In some exemplary embodiments, the plate devices may include any two of a display panel, a touch panel, and a protection sheet. The adhesive layer may be light curing adhesive, thermal setting adhesive or thermal plastic adhesive. Since the cutting apparatus comprises a movable carrier and a reel continuously drives the cutting wire, the plate devices of the touch display can be easily and safely separated from each other. The application not only facilitates efficient separation of two plate devices for rework, but also prevents damage and failure during the cutting process.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A cutting apparatus for separating two plate devices which are connected to each other by an adhesive layer, comprising:
a base;
a carrier movably disposed on the base to hold the plate devices;
a wire; and
a reel mechanism disposed on the base for moving the wire, wherein the wire cuts through the adhesive layer while the carrier moves with respect to the base, so that the plate devices are separated from each other.

2. The cutting apparatus as claimed in claim 1, wherein the base comprises a rail with the carrier sliding thereon.

3. The cutting apparatus as claimed in claim 2, wherein the wire traverses the rail.

4. The cutting apparatus as claimed in claim 1, wherein the carrier moves with respect to the base in a first direction, and the wire moves with respect to the base in a second direction perpendicular to the first direction.

5. The cutting apparatus as claimed in claim 1, wherein the carrier has a recess with the plate devices disposed thereon, and the adhesive layer projects from the recess.

6. The cutting apparatus as claimed in claim 1, wherein the cutting apparatus further comprises a heater disposed below the recess for heating the adhesive layer.

7. The cutting apparatus as claimed in claim 1, wherein the adhesive layer comprises light curing adhesive, thermal setting adhesive, or thermal plastic adhesive.

8. The cutting apparatus as claimed in claim 1, wherein the reel mechanism is an electrical reel or a manual reel.

9. The cutting apparatus as claimed in claim 1, wherein the wire comprises stainless wire, steel wire, cloth wire, nylon wire, wire saw, or wire with abrasive grains.

10. The cutting apparatus as claimed in claim 1, wherein the plate devices include a display panel and a touch panel.

11. The cutting apparatus as claimed in claim 1, wherein the plate devices include a display panel and a protection sheet.

12. The cutting apparatus as claimed in claim 1, wherein the plate devices include a touch panel and a protection sheet.
